(19) United States
(12) Patent Application Publication
(10) Pub. No.: US 2017/0374306 A1
(43) Pub. Date: Dec. 28, 2017

(54) IMAGE SENSOR SYSTEM WITH AN AUTOMATIC FOCUS FUNCTION

(71) Applicant: SEMICONDUCTOR COMPONENTS INDUSTRIES, LLC, Phoenix, AZ (US)

(72) Inventors: Brian Anthony VAARTSTRA, Nampa, ID (US); Nathan Wayne CHAPMAN, Meridian, ID (US)

(73) Assignee: SEMICONDUCTOR COMPONENTS INDUSTRIES, LLC, Phoenix, AZ (US)

(21) Appl. No.: 15/191,319

(22) Filed: Jun. 23, 2016

(51) Int. Cl. H04N 5/369; H04N 5/225; H04N 5/232; H04N 9/04

(52) U.S. Cl. CPC H04N 5/3696; H04N 9/045; H04N 5/2258; H04N 5/23212

(57) ABSTRACT

An imaging system may include at least two image sensors. Each image sensor may have a respective lens module that is configured to focus light on the image sensor. One of the image sensors may be a monochrome sensor, while another image sensor may be a color sensor. The monochrome sensor may include phase detection pixels while the color sensor may not include phase detection pixels. The imaging system may include processing circuitry that is configured to adjust the lens modules for both the monochrome and color sensors based on the data from the phase detection pixels.

### BACKGROUND

This relates generally to imaging systems and, more particularly, to imaging systems with phase detection capabilities.

Modern electronic devices such as cellular telephones, cameras, and computers often use digital image sensors. Imager sensors (sometimes referred to as imagers) may be formed from a two-dimensional array of image sensing pixels. Each pixel receives incident photons (light) and converts the photons into electrical signals. Image sensors are sometimes designed to provide images to electronic devices using a Joint Photographic Experts Group (JPEG) format.

Some applications such as automatic focusing and three-dimensional (3D) imaging may require electronic devices to provide stereo and/or depth sensing capabilities. For example, to bring an object of interest into focus for an image capture, an electronic device may need to identify the distances between the electronic device and object of interest. To identify distances, conventional electronic devices use complex arrangements. Some arrangements require the addition of lenticular arrays that focus incident light on sub-regions of a two-dimensional pixel array. However, these arrangements may lead to reduced spatial resolution, reduced color fidelity, increased cost, and increased complexity.

It would therefore be desirable to be able to provide improved imaging systems with depth sensing capabilities.

### BRIEF DESCRIPTION OF THE DRAWINGS

FIG. 1 is a schematic diagram of an illustrative electronic device with an image sensor that may include phase detection pixels in accordance with an embodiment of the present invention.

FIG. 2A is a cross-sectional side view of illustrative phase detection pixels having photosensitive regions with different and asymmetric angular responses in accordance with an embodiment of the present invention.

FIGS. 2B and 2C are cross-sectional views of the phase detection pixels of FIG. 2A in accordance with an embodiment of the present invention.

FIG. 3 is a diagram of illustrative signal outputs of photosensitive regions of depth sensing pixels for incident light striking the depth sensing pixels at varying angles of incidence in accordance with an embodiment of the present invention.

FIG. 4 is a cross-sectional side view of illustrative phase detection pixels with a microlens formed on a pedestal in accordance with an embodiment of the present invention.

FIG. 5 is a schematic diagram of an illustrative camera module with a monochrome sensor and color sensor that can each be focused using phase detection data from pixels on the monochrome sensor in accordance with an embodiment of the present invention.

FIGS. 6A and 6B are top views of illustrative monochrome and color sensors in accordance with an embodiment of the present invention.

FIGS. 7A-7C are top views of illustrative phase detection pixel groups that may be used in the camera module of FIG. 5 in accordance with an embodiment of the present invention.

### DETAILED DESCRIPTION

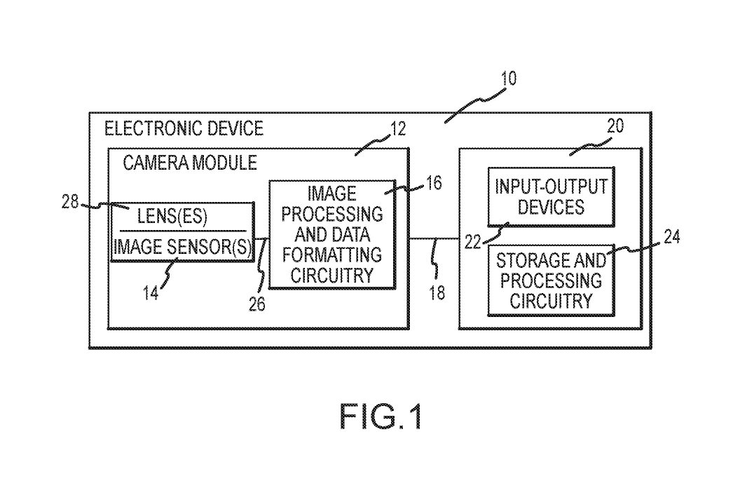

Embodiments of the present invention relate to image sensors with phase detection capabilities. An electronic device with a digital camera module is shown in FIG. 1. Electronic device 10 (sometimes referred to as an imaging system) may be a digital camera, a computer, a cellular telephone, a medical device, or other electronic device. Camera module 12 (sometimes referred to as an imaging device) may include image sensor(s) 14 and one or more lenses 28. During operation, lenses 28 (sometimes referred to as optics 28) focus light onto image sensor(s) 14. There may be one image sensor 14 or more than one image sensor 14 (e.g., two image sensors, three image sensors, four image sensors, more than four image sensors, etc.). Image sensor 14 includes photosensitive elements (e.g., pixels) that convert the light into digital data. Image sensors may have any number of pixels (e.g., hundreds, thousands, millions, or more). A typical image sensor may, for example, have millions of pixels (e.g., megapixels). As examples, image sensor 14 may include bias circuitry (e.g., source follower load circuits), sample and hold circuitry, correlated double sampling (CDS) circuitry, amplifier circuitry, analog-to-digital (ADC) converter circuitry, data output circuitry, memory (e.g., buffer circuitry), address circuitry, etc.

Still and video image data from image sensor(s) 14 may be provided to image processing and data formatting circuitry 16 via path 26. Image processing and data formatting circuitry 16 may be used to perform image processing functions such as automatic focusing functions, depth sensing, data formatting, adjusting white balance and exposure, implementing video image stabilization, face detection, etc. For example, during automatic focusing operations, image processing and data formatting circuitry 16 may process data gathered by phase detection pixels in image sensor 14 to determine the magnitude and direction of lens movement (e.g., movement of lens 28) needed to bring an object of interest into focus.

Image processing and data formatting circuitry 16 may also be used to compress raw camera image files if desired (e.g., to Joint Photographic Experts Group or JPEG format). In a typical arrangement, which is sometimes referred to as a system on chip (SOC) arrangement, camera sensor 14 and image processing and data formatting circuitry 16 are implemented on a common integrated circuit. The use of a single integrated circuit to implement camera sensor 14 and image processing and data formatting circuitry 16 can help to reduce costs. This is, however, merely illustrative. If desired, camera sensor 14 and image processing and data formatting circuitry 16 may be implemented using separate integrated circuits. If desired, camera sensor 14 and image processing circuitry 16 may be formed on separate semiconductor substrates. For example, camera sensor 14 and image processing circuitry 16 may be formed on separate substrates that have been stacked.

Camera module 12 may convey acquired image data to host subsystems 20 over path 18 (e.g., image processing and data formatting circuitry 16 may convey image data to subsystems 20). Electronic device 10 typically provides a user with numerous high-level functions. In a computer or advanced cellular telephone, for example, a user may be provided with the ability to run user applications. To implement these functions, host subsystem 20 of electronic device 10 may include storage and processing circuitry 24 and input-output devices 22 such as keypads, input-output ports, joysticks, and displays. In certain embodiments, input-output devices 22 may include an infrared light source such as an infrared LED. Storage and processing circuitry 24 may include volatile and nonvolatile memory (e.g., random-access memory, flash memory, hard drives, solid-state drives, etc.). Storage and processing circuitry 24 may also include microprocessors, microcontrollers, digital signal processors, application specific integrated circuits, or other processing circuits.

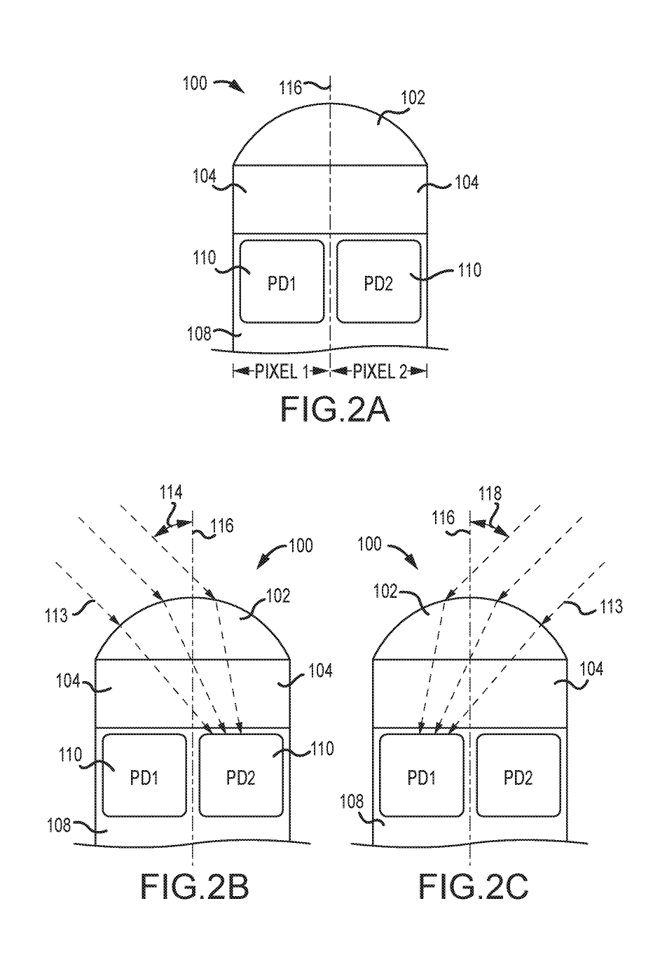

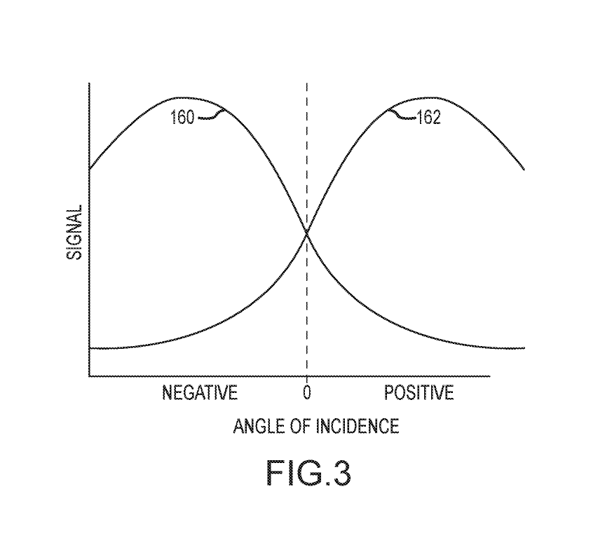

It may be desirable to provide image sensors with depth sensing capabilities (e.g., to use in automatic focusing applications, 3D imaging applications such as machine vision applications, etc.). To provide depth sensing capabilities, image sensor(s) 14 may include phase detection pixel groups. Image sensor(s) 14 may include phase detection pixels such as phase detection pixel group 100 shown in FIG. 2A.

FIG. 2A is an illustrative cross-sectional view of pixel group 100. In FIG. 2A, phase detection pixel group 100 is a pixel pair. Pixel pair 100 may include first and second pixels such Pixel 1 and Pixel 2. Pixel 1 and Pixel 2 may include photosensitive regions such as photosensitive regions 110 formed in a substrate such as silicon substrate 108. For example, Pixel 1 may include an associated photosensitive region such as photodiode PD1, and Pixel 2 may include an associated photosensitive region such as photodiode PD2. A microlens may be formed over photodiodes PD1 and PD2 and may be used to direct incident light towards photodiodes PD1 and PD2. The arrangement of FIG. 2A in which microlens 102 covers two pixel regions may sometimes be referred to as a 2×1 or 1×2 arrangement because there are two phase detection pixels arranged consecutively in a line. In an alternate embodiment, three phase detection pixels may be arranged consecutively in a line in what may sometimes be referred to as a 1×3 or 3×1 arrangement. In other embodiments, phase detection pixels may be grouped in a 2×2 or 2×4 arrangement. In general, phase detection pixels may be arranged in any desired manner.

Color filters such as color filter elements 104 may be interposed between microlens 102 and substrate 108. Color filter elements 104 may filter incident light by only allowing predetermined wavelengths to pass through color filter elements 104 (e.g., color filter 104 may only be transparent to the wavelengths corresponding to a green color, a red color, a blue color, a yellow color, a cyan color, a magenta color, visible light, infrared light, etc.). Color filter 104 may be a broadband color filter. Examples of broadband color filters include yellow color filters (e.g., yellow color filter material that passes red and green light) and clear color filters (e.g., transparent material that passes red, blue, and green light). In general, broadband filter elements may pass two or more colors of light. If desired, no color filter element may be provided and the photodiodes may receive unfiltered light. Photodiodes PD1 and PD2 may serve to absorb incident light focused by microlens 102 and produce pixel signals that correspond to the amount of incident light absorbed.

Photodiodes PD1 and PD2 may each cover approximately half of the substrate area under microlens 102 (as an example). By only covering half of the substrate area, each photosensitive region may be provided with an asymmetric angular response (e.g., photodiode PD1 may produce different image signals based on the angle at which incident light reaches pixel pair 100). The angle at which incident light reaches pixel pair 100 relative to a normal axis 116 (i.e., the angle at which incident light strikes microlens 102 relative to the optical axis 116 of lens 102) may be herein referred to as the incident angle or angle of incidence.

An image sensor can be formed using front side illumination imager arrangements (e.g., when circuitry such as metal interconnect circuitry is interposed between the microlens and photosensitive regions) or backside illumination imager arrangements (e.g., when photosensitive regions are interposed between the microlens and the metal interconnect circuitry). The example of FIGS. 2A, 2B, and 2C in which pixels 1 and 2 are backside illuminated image sensor pixels is merely illustrative. If desired, pixels 1 and 2 may be front side illuminated image sensor pixels. Arrangements in which pixels are backside illuminated image sensor pixels are sometimes described herein as an example. In the example of FIG. 2B, incident light 113 may originate from the left of normal axis 116 and may reach pixel pair 100 with an angle 114 relative to normal axis 116. Angle 114 may be a negative angle of incident light. Incident light 113 that reaches microlens 102 at a negative angle such as angle 114 may be focused towards photodiode PD2. In this scenario, photodiode PD2 may produce relatively high image signals, whereas photodiode PD1 may produce relatively low image signals (e.g., because incident light 113 is not focused towards photodiode PD1).

In the example of FIG. 2C, incident light 113 may originate from the right of normal axis 116 and reach pixel pair 100 with an angle 118 relative to normal axis 116. Angle 118 may be a positive angle of incident light. Incident light that reaches microlens 102 at a positive angle such as angle 118 may be focused towards photodiode PD1 (e.g., the light is not focused towards photodiode PD2). In this scenario, photodiode PD2 may produce an image signal output that is relatively low, whereas photodiode PD1 may produce an image signal output that is relatively high.

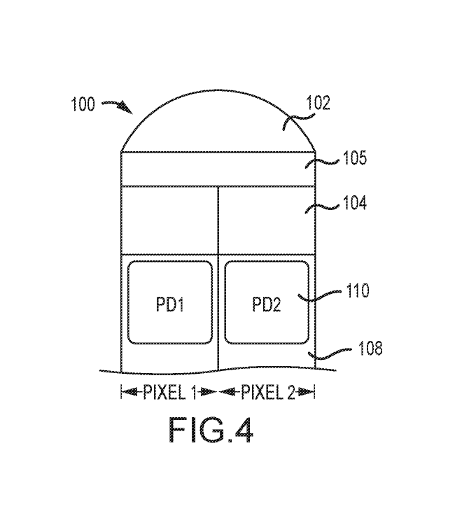

The positions of photodiodes PD1 and PD2 may sometimes be referred to as asymmetric or displaced positions because the center of each photosensitive area 110 is offset from (i.e., not aligned with) optical axis 116 of microlens 102. Due to the asymmetric formation of individual photodiodes PD1 and PD2 in substrate 108, each photosensitive area 110 may have an asymmetric angular response (e.g., the signal output produced by each photodiode 110 in response to incident light with a given intensity may vary based on an angle of incidence). It should be noted that the example of FIGS. 2A-2C where the photodiodes are adjacent is merely illustrative. If desired, the photodiodes may not be adjacent (i.e., the photodiodes may be separated by one or more intervening photodiodes). In the diagram of FIG. 3, an example of the image signal outputs of photodiodes PD1 and PD2 of pixel pair 100 in response to varying angles of incident light is shown.

Line 160 may represent the output image signal for photodiode PD2 whereas line 162 may represent the output image signal for photodiode PD1. For negative angles of incidence, the output image signal for photodiode PD2 may increase (e.g., because incident light is focused onto photodiode PD2) and the output image signal for photodiode PD1 may decrease (e.g., because incident light is focused away from photodiode PD1). For positive angles of incidence, the output image signal for photodiode PD2 may be relatively small and the output image signal for photodiode PD1 may be relatively large.

The size and location of photodiodes PD1 and PD2 of pixel pair 100 of FIGS. 2A, 2B, and 2C are merely illustrative. If desired, the edges of photodiodes PD1 and PD2 may be located at the center of pixel pair 100 or may be shifted slightly away from the center of pixel pair 100 in any direction. If desired, photodiodes 110 may be decreased in size to cover less than half of the pixel area.

Output signals from pixel pairs such as pixel pair 100 may be used to adjust the optics (e.g., one or more lenses such as lenses 28 of FIG. 1) in image sensor(s) 14 during automatic focusing operations. The direction and magnitude of lens movement needed to bring an object of interest into focus may be determined based on the output signals from pixel pairs 100.

For example, by creating pairs of pixels that are sensitive to light from one side of the lens or the other, a phase difference can be determined. This phase difference may be used to determine both how far and in which direction the image sensor optics should be adjusted to bring the object of interest into focus.

When an object is in focus, light from both sides of the image sensor optics converges to create a focused image. When an object is out of focus, the images projected by two sides of the optics do not overlap because they are out of phase with one another. By creating pairs of pixels where each pixel is sensitive to light from one side of the lens or the other, a phase difference can be determined. This phase difference can be used to determine the direction and magnitude of optics movement needed to bring the images into phase and thereby focus the object of interest. Pixel blocks that are used to determine phase difference information such as pixel pair 100 are sometimes referred to herein as phase detection pixels or depth-sensing pixels.

A phase difference signal may be calculated by comparing the output pixel signal of PD1 with that of PD2. For example, a phase difference signal for pixel pair 100 may be determined by subtracting the pixel signal output of PD1 from the pixel signal output of PD2 (e.g., by subtracting line 162 from line 160). For an object at a distance that is less than the focused object distance, the phase difference signal may be negative. For an object at a distance that is greater than the focused object distance, the phase difference signal may be positive. This information may be used to automatically adjust the image sensor optics to bring the object of interest into focus (e.g., by bringing the pixel signals into phase with one another).

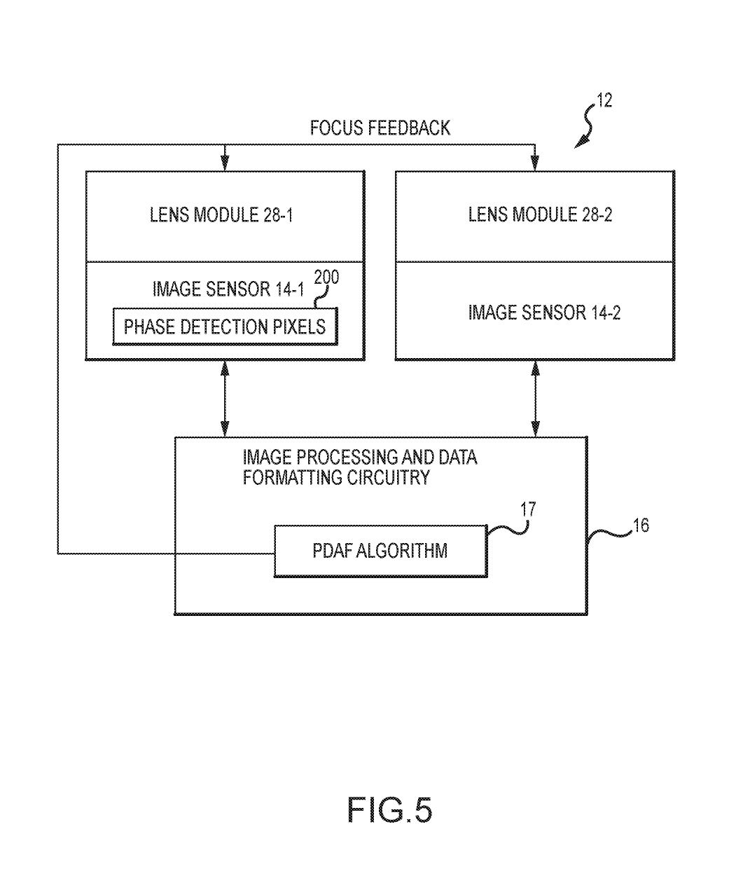

In order to improve phase detection pixel group 100, phase detection pixel group 100 may include pedestal 105, as shown in FIG. 4. Pedestal 105 may increase the stack height of the phase detection pixels and may result in the phase detection pixels having an increased asymmetric angular response and improve the quality of the phase detection data. Pedestal 105 may be formed from any desired material. In certain embodiments, pedestal 105 may be a clear polymer that is transparent to all wavelengths of light. In other embodiments, pedestal 105 may be a color filter element. Pedestal 105 may filter incident light by only allowing predetermined wavelengths to pass through pedestal 105 (e.g., pedestal 105 may only be transparent to certain ranges of wavelengths). In certain embodiments, pedestal 105 may replace the underlying color filter elements 104 entirely. In these embodiments, pedestal 105 may be disposed directly on the surface of substrate 108.

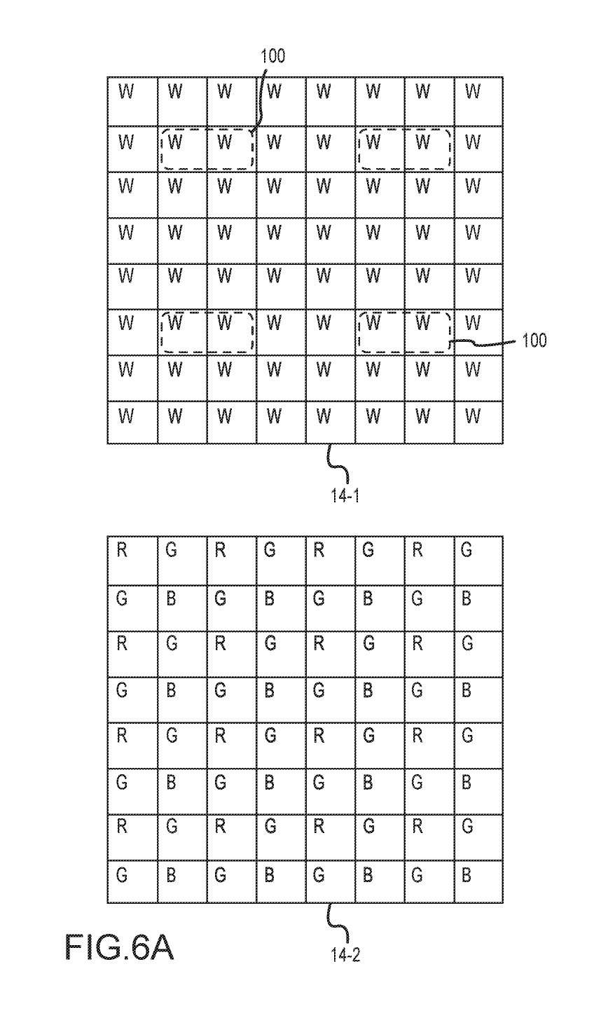

In certain embodiments, an imaging system may include more than one image sensor, only one of which includes phase detection pixels. An example of an embodiment of this type is shown in FIG. 5. As shown in FIG. 5, camera module 12 for an electronic device (e.g., electronic device 10 in FIG. 1) may include a first image sensor 14-1 and a second image sensor 14-2. Each image sensor may have a corresponding lens module. As shown, lens module 28-1 may cover image sensor 14-1, while lens module 28-2 may cover image sensor 14-2. Each lens module may include one or more lenses with any desired characteristics (i.e., any focal length, aperture, and magnification may be used for each lens).

At least one of the image sensors may include phase detection pixels. As shown in FIG. 5, image sensor 14-1 may include phase detection pixels 200. Phase detection pixels 200 may include one or more phase detection pixel groups 100 as described in connection with FIGS. 2-4. Phase detection pixels 200 may be used to gather phase detection data. The phase detection data may be used by a phase detection auto focus (PDAF) algorithm 17 in image processing and data formatting circuitry 16. Similar to as discussed in connection with FIGS. 3 and 4, processing circuitry 16 in FIG. 5 may be used to calculate a phase difference signal from data received by phase detection pixels 200. The phase difference signal may be used to automatically adjust lens modules 28-1 and 28-2 to bring an object of interest into focus.

The phase detection auto focus algorithm may be calibrated during assembly to account for the differences between lens modules 28-1 and 28-2. This way, both image sensors 14-1 and 14-2 can be focused using the phase detection data.

Importantly, it should be noted that image sensor 14-2 may not include any phase detection pixels. Although image sensor 14-2 does not include phase detection pixels, the phase detection data from image sensor 14-1 may be used to generate focus feedback that adjusts lens module 28-2. This concept of using phase detection data from a first image sensor to help focus the lens module of a second image sensor can be used to implement imaging systems that focus quickly.

Image sensor 14-1 may be a monochrome sensor, while image sensor 14-2 may be a color sensor. The monochrome sensor may include pixels of only one color. For example, image sensor 14-1 may include pixels with no color filtration. There may be no color filter material included in image sensor 14-1 at all, or image sensor 14-1 may include exclusively clear or white color filter elements. Alternatively, image sensor 14-1 may include color filter material that is configured to filter a certain color of visible light (e.g., red, green, blue, etc.), infrared light, or ultraviolet light. Image sensor 14-2, on the other hand, may include color filter elements of different colors. Image sensor 14-2 may include, for example, blue, red, and green color filter elements that are arranged according to a Bayer color filter pattern. Other colors or color filter patterns may be used in image sensor 14-2 if desired.

Including phase detection pixels in a color sensor typically necessitates using color correction algorithms in order to account for the unique structure of the phase detection pixels. By including the phase detection pixels on only the monochrome sensor, the camera module shown in FIG. 5 has the advantage of avoiding this possible problem and maintaining the color fidelity in image sensor 14-2. The monochrome sensor, meanwhile, can include any number of phase detection pixels without having to use complicated algorithms to correct for color cross talk.

Another advantage of a monochrome sensor with phase detection pixels is that the monochrome sensor allows for maximum light input, which results in optimal low-light focusing. Additionally, the color sensor can take advantage of the phase detection data from the monochrome sensor to have a similarly high responsivity in all light conditions.

In addition to being used for phase detection applications, monochrome sensor 14-1 may be used for imaging applications. For example, monochrome sensor 14-1 may have some phase detection pixel groups and some imaging pixels. In addition to using phase detection data from the phase detection pixel groups for focusing purposes, the imaging pixels may be used for imaging purposes. One example of this type of application is when a camera module of the type shown in FIG. 5 is used in a cellular telephone. The imaging pixels of the monochrome sensor may enable much faster imaging of barcodes or QR codes compared to a color sensor.

In embodiments where image sensor 14-1 is a monochrome infrared or near-infrared sensor, the imaging system may also include infrared or near-infrared light sources that are configured to emit infrared or near-infrared light. The light source may be an infrared LED, for example. In another embodiment, sensor 14-1 may be a monochrome ultraviolet sensor and an ultraviolet light source may be included in the imaging system.

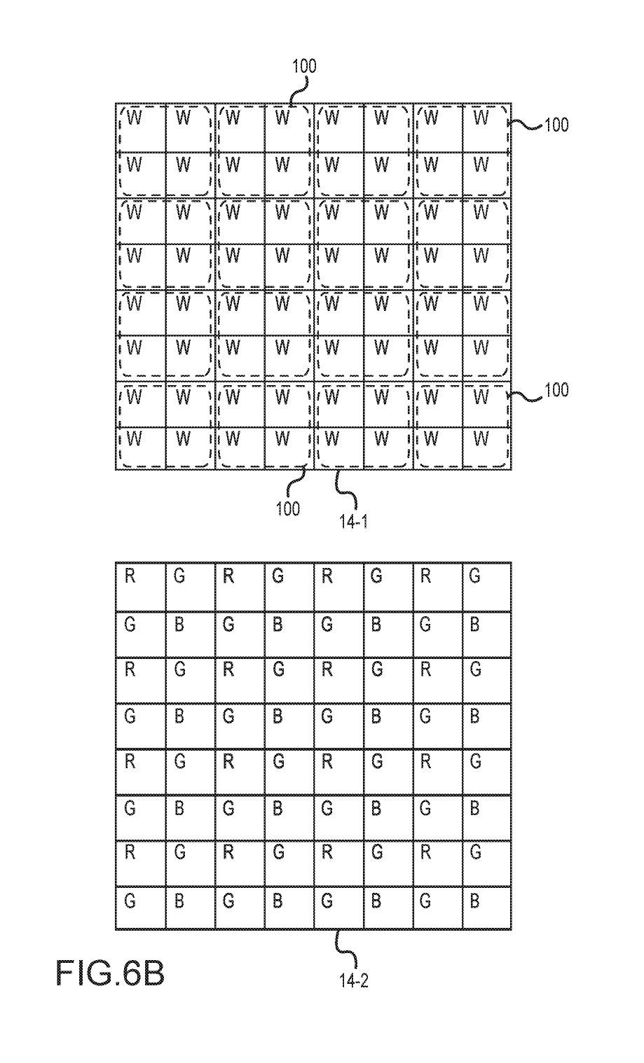

FIG. 6A is an illustrative top view of a dual sensor imaging system with a monochrome sensor and a color sensor. The monochrome sensor may include phase detection pixels that generate phase detection data. The phase detection data may be used to help focus lenses for both the monochrome sensor and the color sensor. Pixels marked with an R include a red color filter, pixels marked with a G include a green color filter, pixels marked with a B include a blue color filter, and pixels marked with a W include a white color filter. Image sensor 14-1 may include exclusively white color filters, while image sensor 14-2 may include red, blue, and green color filter elements. The pattern of color filters in the pixel array for image sensor 14-2 may be a Bayer mosaic pattern that includes a repeating unit cell of two-by-two pixels having two green image pixels arranged on one diagonal and one red and one blue image pixel arranged on the other diagonal. This example is merely illustrative, and other color filter patterns may be used if desired. For example, a broadband color filter (e.g., a yellow or clear color filter) may be used instead of a green color filter in the color filter array. The example of FIG. 6A where image sensor 14-1 includes all white color filters is merely illustrative. Image sensor 14-1 may be any monochrome sensor as discussed in connection with FIG. 5.

As shown in FIG. 6A, image sensor 14-1 may include phase detection pixel groups 100. The phase detection pixel groups may generate phase detection data that is used to focus lens modules for both image sensors 14-1 and 14-2. In FIG. 6A, each phase detection pixel group is a 2×1 pixel group with adjacent photodiodes covered by a single microlens. Additionally, FIG. 6A shows only some pixels in image sensor 14-1 as being part of phase detection pixel groups. In other words, the phase detection pixel groups may be separated by one or more intervening imaging pixels. The imaging pixels may each have a photosensitive region that is covered by a single microlens.

FIG. 6B shows another embodiment of a dual sensor imaging system with a monochrome sensor and a color sensor. Unlike FIG. 6A, the monochrome sensor 14-1 in FIG. 6B has every pixel in a phase detection pixel group. Additionally, the phase detection pixel groups in FIG. 6B are 2×2 groups of pixels. In general, phase detection pixel groups of any size may be used in image sensor 14-1. Any or all of the pixels in image sensor 14-1 may be part of one or more phase detection pixel groups. Additionally, phase detection groups of different sizes may be used in image sensor 14-1. For example, image sensor 14-1 may include one or more 2×1 phase detection pixel groups and one or more 2×2 phase detection pixel groups.

Signals from phase detection pixels may also be binned if desired. For example, if it is desired to use monochrome sensor 14-1 for imaging purposes, the signals from each pixel in a 2×2 group of pixels may be binned or summed. If each 2×2 group of pixels is binned, the data can be used for imaging purposes. In general, the data from the phase detection pixels or imaging pixels can be binned in any desired manner for any desired purpose.

Including phase detection pixel groups across the entire array (as shown in FIG. 6B) may enable preferential fast focusing in certain areas of the array. For example, the sensors of FIG. 6B may be included in an electronic device that also includes a touch screen (as one of input-output devices 22, for example). A user may select a desired region of an image to be focused by touching the touch screen. Depth map information from the monochrome sensor in the desired region may then be used to focus the desired region very rapidly.

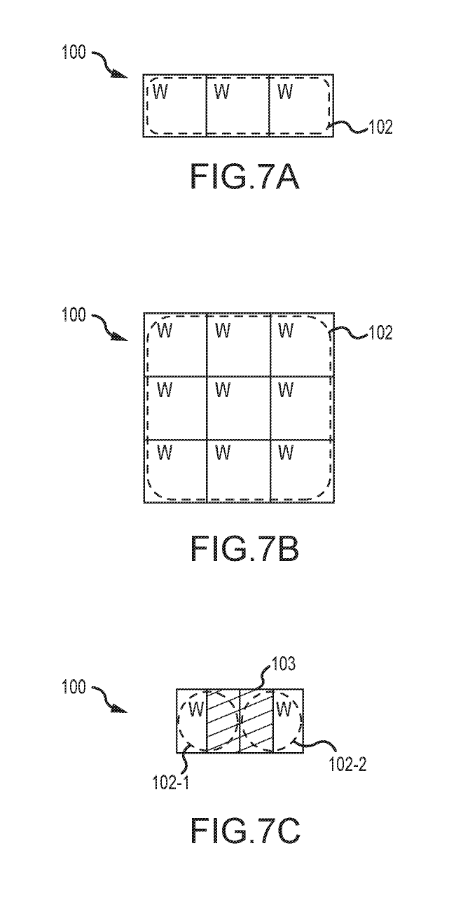

Examples of numerous phase detection pixel groups have been described above. FIGS. 7A-7C show additional phase detection pixel groups that may be included in an image sensor such as image sensor 14-1 in FIG. 5. FIG. 7A shows a 1×3 phase detection pixel group where three adjacent pixels are covered by a single microlens 102. The 1×3 phase detection phase detection pixel group may be oriented horizontally (i.e., a microlens covers three adjacent pixels in a single row) or vertically (i.e., a microlens covers three adjacent pixels in a single column). FIG. 7B shows a 3×3 phase detection pixel group where a 3×3 grid of pixels is covered by a single microlens. Larger groups may be used if desired (e.g., a 4×4 group, a 5×5 group, etc.). FIG. 7 shows an illustrative phase detection pixel group where adjacent pixels are each covered by respective microlenses 102-1 and 102-2. However, a shielding element 103 is provided to cover a portion of the underlying photosensitive regions and ensure that each pixel has an asymmetric response to incident light. Shielding layer 103 may formed from metal or another material that is opaque to incident light. Phase detection pixel groups that utilize shielding elements in any way may also be used in image sensor 14-1.

Additionally, phase detection pixel groups may be included where more than one microlens covers the pixels. For example, three adjacent pixels in a 1×3 group may make up a phase detection pixel group. Instead of a single microlens covering all three pixels, two microlenses may each cover approximately 1.5 pixels. In yet another embodiment, phase detection pixels may have various sub-pixels, such as an inner sub-pixel that is nested within an outer sub-pixel. Microlenses of any shape can be used in phase detection pixel groups (e.g., circular, elliptical, toroidal, etc.). In general, image sensor 14-1 may include any pixel group capable of generating phase detection data. The phase detection data may then be used to focus lens modules 28-1 and 28-2.

In various embodiments of the present invention, an imaging system may include a first image sensor that includes phase detection pixels, a first lens module that is configured to focus light on the first image sensor, a second image sensor that does not include phase detection pixels, a second lens module that is configured to focus light on the second image sensor, and processing circuitry that is configured to adjust the second lens module based on phase detection data from the phase detection pixels.

The first image sensor may be a monochrome image sensor, and the second image sensor may be a color image sensor. The monochrome image sensor may be configured to detect white light. The monochrome image sensor may include a color filter material that covers all of the pixels in the monochrome image sensor. The color filter material may be configured to pass light of a given type, wherein the given type is selected from the group consisting of: visible light, infrared light, near-infrared light, and ultraviolet light. The phase detection pixels may be organized in phase detection pixel groups, and each phase detection pixel group may include adjacent pixels covered by a single microlens. The single microlens may be formed on a pedestal. At least one phase detection pixel group may include a shielding element that covers portions of underlying pixels. The phase detection pixels may be organized in phase detection pixel groups, and each phase detection pixel group may include a group of pixels covered by a single microlens, and each group of pixels may be selected from the group consisting of: a 1×2 group, a 1×3 group, a 2×2 group, a 2×4 group, a 3×3 group, and a 4×4 group.

A method of operating an imaging system that includes at least one monochrome sensor with phase detection pixels and at least one color sensor may include generating phase detection pixel data with the phase detection pixels, and adjusting a first lens based on the phase detection pixel data. The first lens may be positioned above the at least one color sensor. The method may also include adjusting a second lens based on the phase detection pixel data. The second lens may be positioned above the at least one monochrome sensor. The at least one color sensor may not include any phase detection pixels. The method may also include generating image data using the at least one monochrome sensor.

An imaging system may include a monochrome image sensor, a first lens module that is configured to focus light on the monochrome image sensor, a color image sensor, and a second lens module that is configured to focus light on the color image sensor. The monochrome image sensor may include phase detection pixels, the color image sensor may include imaging pixels, the color image sensor may not include phase detection pixels, the color image sensor may include a color filter array with a plurality of color filter elements, and the plurality of color filter elements may include at least color filter elements of a first color and color filter elements of a second color that is different than the first color.

The imaging system may also include processing circuitry that is configured to receive data from the monochrome image sensor and color image sensor. The processing circuitry may be configured to adjust the second lens module based on phase detection data from the phase detection pixels. The processing circuitry may be configured to adjust the first lens module based on the phase detection data from the phase detection pixels. The phase detection pixels may include at least first and second pixels covered by a single microlens. The plurality of color filter elements may be arranged according to a Bayer color filter pattern.

The foregoing is merely illustrative of the principles of this invention and various modifications can be made by those skilled in the art without departing from the scope and spirit of the invention.

1. An imaging system comprising:
a first image sensor that includes imaging pixels and phase detection pixels;
a first lens module that is configured to focus light on the first image sensor;
a second image sensor that does not include phase detection pixels;
a second lens module that is configured to focus light on the second image sensor; and
processing circuitry that is configured to adjust the second lens module based on phase detection data from the phase detection pixels.

2. The imaging system defined in claim 1, wherein the first image sensor is a monochrome image sensor.

3. The imaging system defined in claim 2, wherein the second image sensor is a color image sensor.

4. The imaging system defined in claim 3, wherein the monochrome image sensor is configured to detect white light.

5. The imaging system defined in claim 3, wherein the monochrome image sensor comprises a color filter material that covers all of the pixels in the monochrome image sensor.

6. The imaging system defined in claim 5, wherein the color filter material is configured to pass light of a given type, wherein the given type is selected from the group consisting of: visible light, infrared light, near-infrared light, and ultraviolet light.

7. The imaging system defined in claim 1, further comprising a plurality of microlenses, wherein the phase detection pixels are organized in phase detection pixel groups, and wherein each phase detection pixel group of the phase detection pixel groups comprises adjacent pixels covered by a single microlens of the plurality of microlenses.

8. (canceled)

9. The imaging system defined in claim 7, wherein at least one phase detection pixel group includes a shielding element that covers portions of underlying pixels.

10. The imaging system defined in claim 1, wherein the phase detection pixels are organized in phase detection pixel groups, and wherein a first phase detection pixel group of the phase detection pixel groups comprises a 1×3 group of pixels covered by a single microlens.

11. A method of operating an imaging system, wherein the imaging system includes at least one monochrome sensor and at least one color sensor, and wherein the at least one monochrome sensor includes phase detection pixels, the method comprising:
with the phase detection pixels, generating phase detection pixel data;
based on the phase detection pixel data, adjusting a first lens, wherein the first lens is positioned above the at least one color sensor; and
based on the phase detection pixel data, adjusting a second lens, wherein the second lens is positioned above the at least one monochrome sensor.

12. (canceled)

13. The method defined in claim 11, wherein the at least one color sensor does not include any phase detection pixels.

14. (canceled)

15. An imaging system comprising:
a monochrome image sensor, wherein the monochrome image sensor includes phase detection pixels and imaging pixels, wherein the phase detection pixels comprise first and second phase detection pixels covered by a first microlens, and wherein each imaging pixel of the imaging pixels is covered by a respective single microlens;
a first lens module that is configured to focus light on the monochrome image sensor;
a color image sensor, wherein the color image sensor includes imaging pixels, wherein the color image sensor does not include phase detection pixels, wherein the color image sensor comprise a color filter array with a plurality of color filter elements, and wherein the plurality of color filter elements includes at least color filter elements of a first color and color filter elements of a second color that is different than the first color;
a second lens module that is configured to focus light on the color image sensor; and
processing circuitry that is configured to receive data from the monochrome image sensor and color image sensor and adjust the second lens module based on the data received from the phase detection pixels of the monochrome image sensor.

16. (canceled)

17. (canceled)

18. The imaging system defined in claim 15, wherein the processing circuitry is configured to adjust the first lens module based on the data received from the phase detection pixels of the monochrome image sensor.

19. (canceled)

20. The imaging system defined in claim 15, wherein the plurality of color filter elements are arranged according to a Bayer color filter pattern.

21. The imaging system defined in claim 7, wherein each imaging pixel of the first image sensor is covered by a single microlens of the plurality of microlenses.

22. The imaging system defined in claim 21, wherein the first image sensor does not receive light from the second lens module.

23. The imaging system defined in claim 22, wherein the second image sensor does not receive light from the first lens module.

24. The imaging system defined in claim 11, wherein the first lens is configured to focus light on the at least one color sensor without focusing light on the at least one monochrome sensor.

25. The imaging system defined in claim 24, wherein the second lens is configured to focus light on the at least one monochrome sensor without focusing light on the at least one color sensor.

26. The imaging system defined in claim 15, wherein the monochrome image sensor includes a first total number of pixels, wherein the color image sensor includes a second total number of pixels, and wherein the first total number of pixels is equal to the second total number of pixels.
